(19) United States
(12) Patent Application Publication
(10) Pub. No.: US 2010/0131838 A1
(43) Pub. Date: May 27, 2010

(54) WEB EXTENSION MECHANISM

(76) Inventor: John Palmieri, Cambridge, MA (US)

Correspondence Address: RED HAT/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/324,741

(22) Filed: Nov. 26, 2008

(51) Int. Cl. G06F 17/00

(52) U.S. Cl. 715/234

(57) ABSTRACT

An an extension module to enhance the functionality of a web page. An extension point module searches a web page for an extension point and determines an extension point type for the extension point. The extension point module requests a plurality of extensions corresponding to the extension point type. The extension module provides an extension unit comprising a plurality of extensions corresponding to the extension point type. The extension point module runs each of the plurality of extensions in the extension unit on the extension point, wherein running each of the plurality of extensions on the extension point adds functionality to the web page.

### TECHNICAL FIELD

Embodiments of the present invention relate to a method and system for enhancing the functionality of a web page. Specifically, the embodiments of the present invention relate to a method and system for adding functionality to a web page in real-time using an extension and an extension point.

### BACKGROUND

A web application programmer typically needs to know all of the data to be displayed in a web page prior to designing a web application. However, there are times when a web application developer does not have all of the information readily available at the design phase. For example, a developer designing a web page to display the current build information of a software package does not have the specific information to be displayed in the web page, such as a build identification number and software releases for that build number. In such cases, a software developer needs to first obtain the information before writing the web application. Obtaining all of the information needed to be displayed in a web application before designing the application has proven to be an inefficient process.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 is a diagram of one embodiment of a web extension system.

FIG. 2 is a flowchart of one embodiment of a process for enhancing the functionality of a web page using an extension and an extension point.

FIG. 3 is a flowchart of one embodiment of a process for providing the extensions corresponding to an extension point type.

FIG. 4 is a diagram of one embodiment of the web extension system.

### DETAILED DESCRIPTION

Described herein is a method and system for enhancing the functionality of a web page using an extension and an extension point. An extension module provides an extension unit having the extensions corresponding to the extension point type. An extension point module executes one or more extensions on an extension point found in a web page. A search module searches a web page for an extension point and an extension determination module determines an extension point type for the extension point. A retrieval module requests extensions corresponding to the extension point type. The extension point module runs each of the extensions in the extension unit on the extension point, wherein running each of the extensions on the extension point adds functionality to the web page in real-time. This method and system allows a web application programmer to design and implement a web page without having the data to be displayed in the web page at the design and implementation stage. The web application programmer supports this system in the form of extensions running on extension points in a web page to add functionality to a web page (e.g., retrieve, process, and display data not readily available at the time of designing the web page).

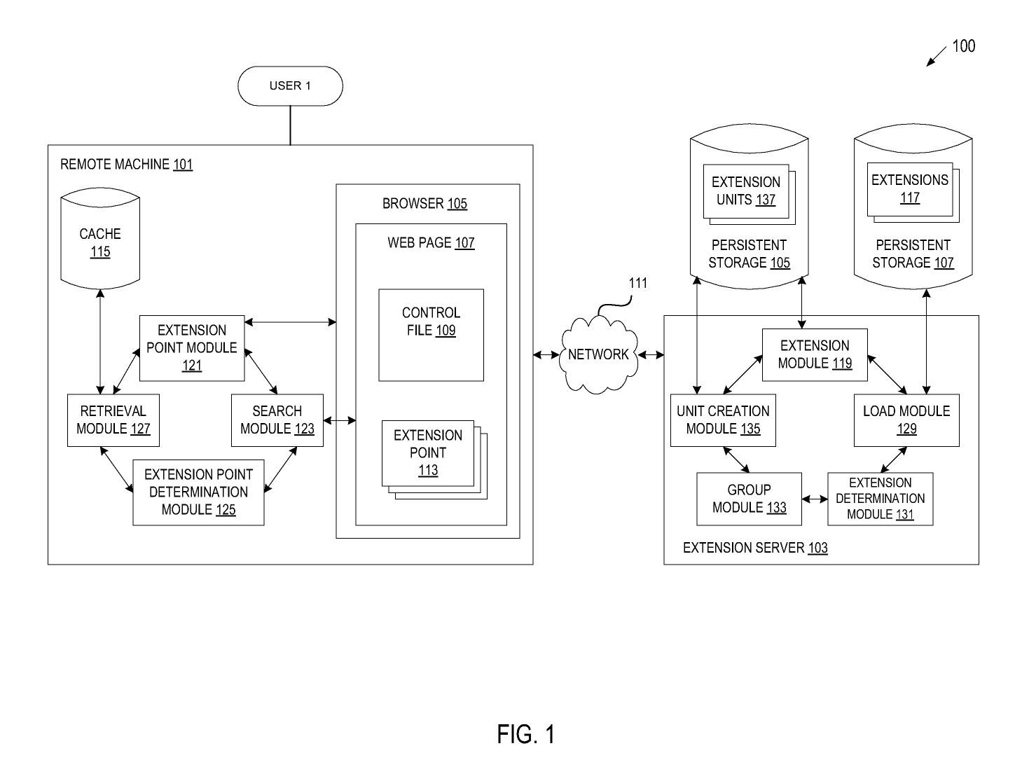

FIG. 1 is a diagram of one embodiment of the web extension system 100. The system 100 includes any number of remote machines 101 (client machine), an extension server 103, a persistent storage unit 107 for saving extensions 117 and a persistent storage unit 105 for storing extension units 137. The extension server 103 can be accessible to any number of remote machines 101 and users through a network 111. The network 111 can be local area network (LAN), such as an intranet within a company, a wide are network (WAN), such as the Internet or similar communication system. The network 111 can include any number of networking and computing devices including any number of wired and wireless devices.

Remote machine 101 can be any type of computing device including desktop computers, laptop computers, handheld computers or similar computing device. The remote machine 101 accesses a web page 139 using a general purpose browser 137 or a specialized application. The remote machine 101 includes an extension point module 121, a search module 123, an extension point determination module 125, a retrieval module 127, a cache 115 and similar components. This division of functionality is presented by way example for sake of clarity. One skilled in the art would understand that the functionality described could be combined into a monolithic component or sub-divided into any combination of components.

The extension point module 121 runs one or more extensions on an extension point in a web page to add functionality to the web page in real-time. For example, when a web page is loaded the extension point module can run build extensions on a build extension point in the web page to display data relating to the build (e.g., release information for that build). An extension is the code processed by a control file (e.g., JavaScript file) to run on an extension point. The extension is packaged in a way that makes it callable through an extension point. An extension point is a marker of structured data that is part of a web page's markup language (e.g., HTML) indicating that code of a certain type can be executed at that extension point location. An extension point allows for the ability to relate data where no hard data relationship was initially intended. For example, a user includes ‘My Interests’ data in a profile web page that indicates an interest in skiing. The profile web page includes a ‘my interests’ extension point that attaches to the ‘My Interests’ data. A ‘map’ extension which shows a map highlighting all of a user's interests in a user's geographical area is installed on the extension server. The next time the user accesses the profile web page, the ‘map’ extension will run on the ‘my interest’ extension point and the user will see a map of the user's area with all of the ski resorts highlighted. In addition, extension points can link two or more web sites over similar data. For example, site A runs a ‘copy’ extension on a ‘my interests’ extension point that copies the data to its own server (e.g., the server hosting site A). Site B runs the same ‘copy’ extension on a ‘my interests’ extension point that copies the data to its own server (e.g., the server hosting site B). The next time a user accessing site A or another user accessing site B logs in, they are notified by the extension that there is someone in the area that has an interest in skiing.

The extension point module 121 detects a browser 137 loading a web page 139 and a control file 109. A control file 109 (e.g., a separate JavaScript file) instructs the browser 137 to process an extension point 113 in the web page 139 using the extensions 117 received from the extension server 103.

The extension point module 121 interfaces with a search module 123 to search the markup language (e.g., HTML) of a loaded web page 139 for one or more extension points 113. The extension point determination module 125 determines an extension point type for each extension point 113 the search module 123 finds. The extension point module 121 interfaces with the retrieval module 127 to request the extensions 117 from an extension server 103 to run on an extension point 113.

The retrieval module 127 retrieves the extensions that correspond to each extension point type determined by the extension point determination module 125. In one embodiment, the retrieval module 127 determines whether the extensions corresponding to an extension point type are stored locally in a cache 115 and retrieves the extensions from the cache 115. In another embodiment, the extension point module 121 interfaces with the retrieval module 127 to send a request to an extension server 103 for the extensions corresponding to an extension point type. The retrieval module 127 receives from the extension server 103 an extension unit 137 having the extensions 117 corresponding to an extension point type. The retrieval module 127 stores the extension unit 137 having the extensions 117 corresponding to an extension point type in a cache 115.

One or more extension servers 103 provide the extensions 117 to the remote machine 101. The extension server 103 can be a desktop computer, laptop computer, dedicated server, mainframe, console device, wireless device or similar computing device. The extension server 103 includes an extension module 119, a load module 129, an extension determination module 131, a group module 133, a unit creation module 135 and similar components. This division of functionality is presented by way example for sake of clarity. One skilled in the art would understand that the functionality described could be combined into a monolithic component or sub-divided into any combination of components.

The extension module 119 receives a request from the remote machine 101 for extensions corresponding to an extension point type. The extension module 119 interfaces with the load module 129 to load extensions 117. The load module 129 interfaces with a persistent storage unit 107 that stores extensions 117. The persistent storage unit 107 may be a local storage unit or a remote storage unit. The persistent storage unit 107 may be a magnetic storage unit, optical storage unit, solid state storage unit or similar storage unit. The persistent storage unit 107 can be a monolithic device or a distributed set of devices.

The extension determination module 131 determines an extension type for each extension loaded by the load module 129. The group module 133 groups together the extensions having the same extension type. The unit creation module 135 creates an extension unit 137 for each group of extensions 117 having the same extension type. The unit creation module 135 stores the extension units 137 in a persistent storage unit 105. The persistent storage unit 105 may be a local storage unit or a remote storage unit. The persistent storage unit 105 may be a magnetic storage unit, optical storage unit, solid state storage unit or similar storage unit. The persistent storage unit 105 can be a monolithic device or a distributed set of devices. A ‘set,’ as used herein, refers to any positive whole number of items including one. The extension units 137 can be stored in a database, file system or similar data storage system. The extension module 119 provides an extension unit having the extensions corresponding to an extension point type to the remote machine 101.

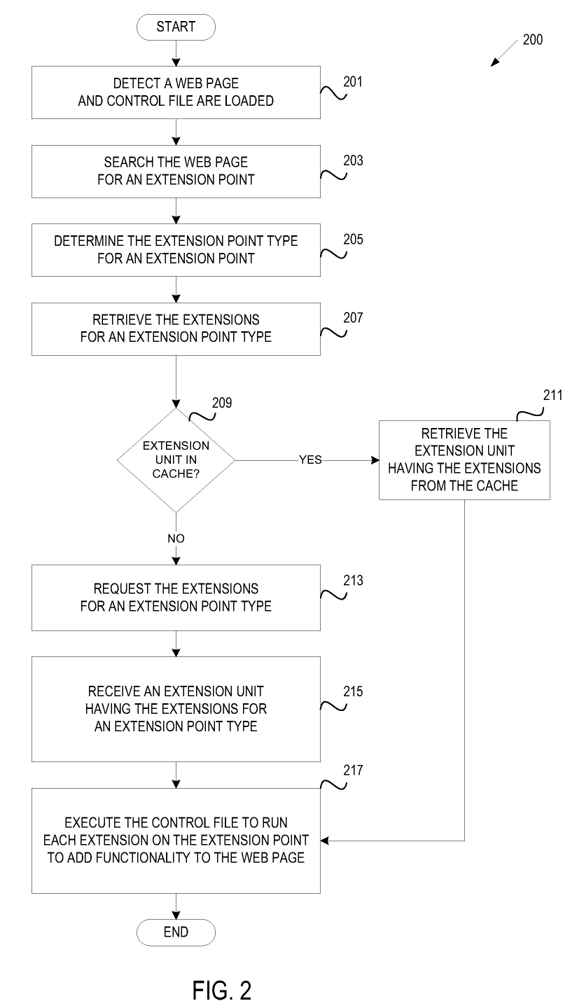

FIG. 2 is flow chart of one embodiment of a process for enhancing the functionality of a web page in real-time using an extension and an extension point. In one embodiment, this process can be initiated by an extension point module detecting a browser loading a web page and a control file (Block 201). The control file (e.g., JavaScript file) is a file for executing an extension on an extension point. At block 203, a search module searches the loaded web page for one or more extension points. The search module searches the markup language of the web page for a script tag indicating an extension point.

At block 205, an extension point determination module determines an extension point type for each extension point found in the web page. For example, the extension point determination module determines an extension point found in the web page is of a build extension type. At block 207, a retrieval module retrieves the extensions corresponding to the extension point type. For example, the retrieval module retrieves build extensions for a build extension point type.

In one embodiment, at block 209, the retrieval module determines whether the extensions corresponding to an extension point type are stored locally in a cache. The extensions are stored as an extension unit. An extension unit is a group of extensions having the same extension point type. If, at block 209, the retrieval module determines the extension unit having the extensions corresponding to the extension point type is stored in the cache, the retrieval module retrieves the extension unit from the cache at block 211. If, at block 209, the retrieval module determines the extension unit having the extensions corresponding to the extension point type is not stored in the cache, the method continues to block 213.

At block 213, the retrieval module sends a request to an extension server for the extensions corresponding to an extension point type. The retrieval module may request the extensions using HTML or HTTP request. The request may include the extension point type. At block 215, the retrieval module receives an extension unit having the extensions corresponding to an extension point type. The retrieval module stores the extension unit and the extensions corresponding to an extension point type in memory (e.g., cache).

At block 217, an extension point module executes the control file (e.g., JavaScript file) to run each extension in the extension unit on the extension point having the corresponding extension point type. The extension point module executes the control file to call a run method to run each extension on the extension point. The execution of an extension on an extension point adds functionality to the web page. An example of adding functionality to a web page is running an extension on an extension point which retrieves a build identification (ID), determines if that build ID has been released, displays the release information of that build ID in the web page, and provides the capability of releasing the package if the package is eligible for release.

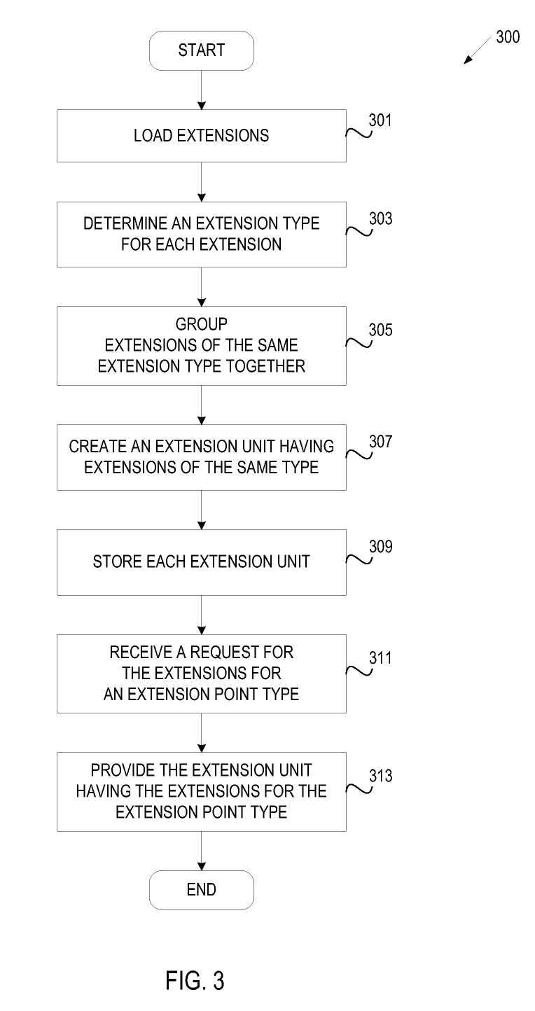

FIG. 3 is a flowchart of one embodiment of a process for providing an extension unit having extensions corresponding to an extension point type. In one embodiment, this process can be initiated by a load module loading extensions from an extension directory (Block 301). At block 303, an extension determination module determines an extension type for each extension. At block 305, a group module groups extensions of the same extension type together. For example, the group module groups extensions for builds together, extensions for releases together, and extensions for alerts together. At block 307, a unit creation module creates an extension unit having the extensions of the same extension type. The unit creation modules compresses the extensions in one group into an extension unit.

At block 309, the unit creation module stores each extension unit. The extension units may be stored in memory. At block 311, the extension module receives a request for the extensions corresponding to an extension point type. At block 313, the extension module provides the extension unit having the extensions corresponding to the extension point type.

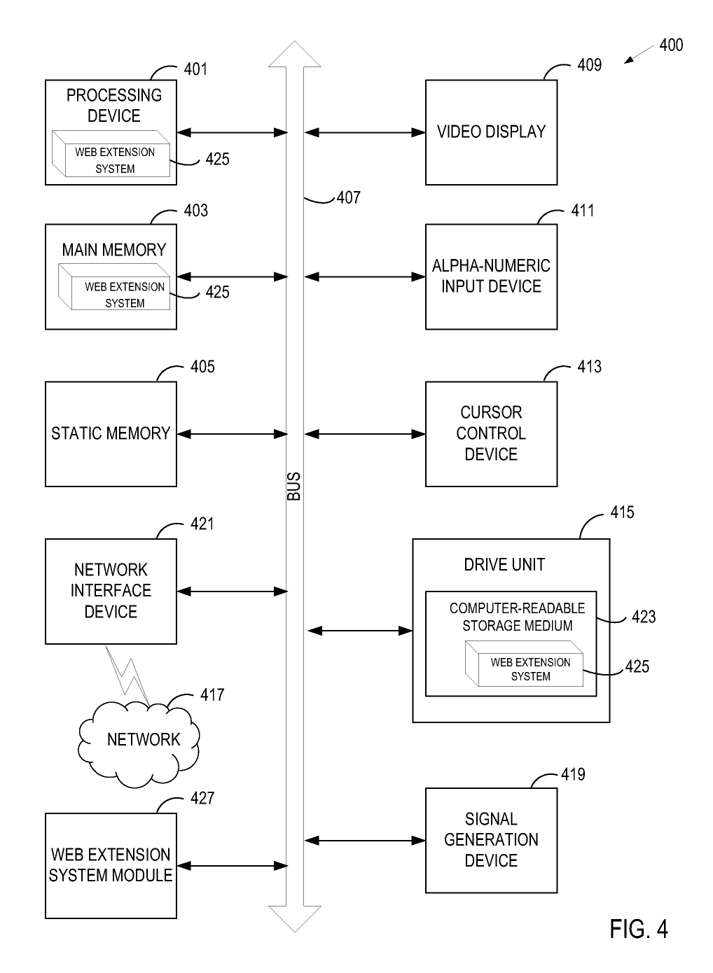

FIG. 4 is a diagram of one embodiment of a computer system for web extension. Within the computer system 400 is a set of instructions for causing the machine to perform any one or more of the methodologies discussed herein. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a console device or set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 400 includes a processing device 401, a main memory 403 (e.g., read-only memory (ROM), flash memory, dynamic random access memory (DRAM) such as synchronous DRAM (SDRAM) or Rambus DRAM (RDRAM), etc.), a static memory 405 (e.g., flash memory, static random access memory (SRAM), etc.), and a secondary memory 415 (e.g., a data storage device in the form of a drive unit, which may include fixed or removable computer-readable storage medium), which communicate with each other via a bus 407.

Processing device 401 represents one or more general-purpose processing devices such as a microprocessor, central processing unit, or the like. More particularly, the processing device 401 may be a complex instruction set computing (CISC) microprocessor, reduced instruction set computing (RISC) microprocessor, very long instruction word (VLIW) microprocessor, processing device implementing other instruction sets, or processing devices implementing a combination of instruction sets. Processing device 401 may also be one or more special-purpose processing devices such as an application specific integrated circuit (ASIC), a field programmable gate array (FPGA), a digital signal processing device (DSP), network processing device, or the like. Processing device 401 is configured to execute the web extension system 425 for performing the operations and steps discussed herein.

The computer system 400 may further include a network interface device 421. The computer system 400 also may include a video display unit 409 (e.g., a liquid crystal display (LCD) or a cathode ray tube (CRT)) connected to the computer system through a graphics port and graphics chipset, an alphanumeric input device 411 (e.g., a keyboard), a cursor control device 413 (e.g., a mouse), and a signal generation device 419 (e.g., a speaker).

The secondary memory 415 may include a computer-readable storage medium (or more specifically a computer-readable storage medium) 423 on which is stored one or more sets of instructions (e.g., the web extension system 425) embodying any one or more of the methodologies or functions described herein. The web extension system 425 may also reside, completely or at least partially, within the main memory 403 and/or within the processing device 401 during execution thereof by the computer system 400, the main memory 403 and the processing device 401 also constituting computer-readable storage media. The web extension system 425 may further be transmitted or received over a network 417 via the network interface device 421.

The computer-readable storage medium 423 may also be used to store the web extension system 425 persistently. While the computer-readable storage medium 423 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media.

The modules 427, components and other features described herein (for example in relation to FIG. 1) can be implemented as discrete hardware components or integrated in the functionality of hardware components such as ASICS, FPGAs, DSPs or similar devices. In addition, the modules 427 can be implemented as firmware or functional circuitry within hardware devices. Further, the modules 427 can be implemented in any combination hardware devices and software components.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “searching,” “providing,” “loading,” “determining,” “grouping,” “storing,” “receiving,” “executing,” “retrieving,” “sending,” or the like, refer to the actions and processes of a computer system, or similar electronic computing device that manipulates and transforms data represented as physical (electronic) quantities within the computer system's registers and memories into other data similarly represented as physical quantities within the computer system memories, registers or other such information storage, transmission or display devices.

The present invention also relates to an apparatus for performing the operations herein. This apparatus may be specially constructed for the required purposes or it may comprise a general purpose computer selectively activated or reconfigured by a computer program stored in the computer. Such a computer program may be stored in a computer-readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards or any type of media suitable for storing electronic instructions, each of which may be coupled to a computer system bus.

The algorithms and displays presented herein are not inherently related to any particular computer or other apparatus. Various general purpose systems may be used with programs in accordance with the teachings herein or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A computer-readable storage medium includes any mechanism for storing information in a form readable by a computer. For example, a computer-readable storage medium includes read only memory (“ROM”), random access memory (“RAM”), magnetic disk storage media; optical storage media, flash memory devices or other type of machine-accessible storage media.

Thus, a method and apparatus for installing live operating systems to removable storage devices has been described. It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A computer-implemented method comprising:
creating an extension unit by a unit creation module, wherein each extension unit comprises a plurality of extensions corresponding to an extension point type;
receiving a request for a plurality of extensions corresponding to an extension point type through an extension module; and
providing an extension unit comprising the plurality of extensions corresponding to the extension point type by the extension module.

2.-24. (canceled)

25. The computer-implemented method of claim 1, further comprising:
loading a plurality of extensions from a directory;
determining an extension type for each extension;
grouping extensions of a same extension type.

26. The computer-implemented method of claim 25, further comprising:
storing each extension unit in a repository.

27. A computer-implemented method comprising:
searching a markup language of a web page for an extension point by a search module;
retrieving a plurality of extensions to run on the extension point by a retrieval module; and
executing each of the plurality of extensions on the extension point by an extension point module, wherein executing each of the plurality of extensions on the extension point adds functionality to the web page.

28. The computer-implemented method of claim 27, executing each of the plurality of extensions on the extension point comprises:
executing a control file to call a run method to run each of the plurality of extensions on the extension point.

29. The computer-implemented method of claim 28, wherein the control file is a JavaScript file.

30. The computer-implemented method of claim 27, retrieving a plurality of extensions to run on the extension point comprises:
determining an extension point type for the extension point; and
retrieving a plurality of extensions corresponding to the extension point type.

31. The computer-implemented method of claim 30, wherein retrieving a plurality of extensions corresponding to the extension point type comprises:
determining whether an extension unit comprising the plurality of extensions corresponding to the extension point type is stored in a cache; and
retrieving the extension unit from the cache if the extension unit is stored in the cache.

32. The computer-implemented method of claim 30, retrieving a plurality of extensions corresponding to the extension point type comprises:
sending a request for the plurality of extensions corresponding to the extension point type, wherein the request includes the extension point type; and
receiving an extension unit comprising the plurality of extensions corresponding to the extension point type.

33. The computer-implemented method of claim 27, wherein the extension point is structured data inside the markup language.

34. The computer-implemented method of claim 27, wherein searching the markup language of the web page for an extension point comprises:
searching for a script tag indicating an extension point by the search module.

35. A computer-readable storage medium, including instructions that, when executed by a computer system, cause the computer system to perform a set of operations comprising:
creating an extension unit by a unit creation module, wherein each extension unit comprises a plurality of extensions corresponding to an extension point type;
receiving a request for a plurality of extensions corresponding to an extension point type through an extension module; and
providing an extension unit comprising the plurality of extensions corresponding to the extension point type by the extension module.

36. The computer-readable storage medium of claim 35, further comprising:
loading a plurality of extensions from a directory;
determining an extension type for each extension;
grouping extensions of a same extension type.

37. The computer-readable storage medium of claim 35, further comprising:
storing each extension unit in a repository.

38. A computer-readable storage medium, including instructions that, when executed by a computer system, cause the computer system to perform a set of operations comprising:
searching a markup language of a web page for an extension point by a search module;
retrieving a plurality of extensions to run on the extension point by a retrieval module; and
executing each of the plurality of extensions on the extension point by an extension point module, wherein executing each of the plurality of extensions on the extension point adds functionality to the web page.

39. The computer-readable storage medium of claim 38, executing each of the plurality of extensions on the extension point comprises:
executing a control file to call a run method to run each of the plurality of extensions on the extension point.

40. The computer-readable storage medium of claim 39, wherein the control file is a JavaScript file.

41. The computer-readable storage medium of claim 38, retrieving a plurality of extensions to run on the extension point comprises:
determining an extension point type for the extension point; and
retrieving a plurality of extensions corresponding to the extension point type.

42. The computer-readable storage medium of claim 41, wherein retrieving a plurality of extensions corresponding to the extension point type comprises:
determining whether an extension unit comprising the plurality of extensions corresponding to the extension point type is stored in a cache; and
retrieving the extension unit from the cache if the extension unit is stored in the cache.

43. The computer-readable storage medium of claim 41, retrieving a plurality of extensions corresponding to the extension point type comprises:
sending a request for the plurality of extensions corresponding to the extension point type, wherein the request includes the extension point type; and
receiving an extension unit comprising the plurality of extensions corresponding to the extension point type.

44. The computer-readable storage medium of claim 38, wherein the extension point is structured data inside the markup language.

45. The computer-readable storage medium of claim 38, wherein searching the markup language of the web page for an extension point comprises:
searching for a script tag indicating an extension point by the search module.

46. A system comprising:
a unit creation module to create an extension unit, wherein an extension unit comprises a plurality of extensions corresponding to an extension point type; and
an extension module, coupled to the unit creation module, the extension module to receive a request for a plurality of extensions corresponding to an extension point type and to provide the extension unit comprising the plurality of extensions corresponding to the extension point type.

47. The system of claim 46, further comprising:
a load module to load a plurality of extensions from a directory;
an extension determination module to determine an extension type for each extension; and
a group module to group extensions of a same extension type.
